(19) United States
(12) Patent Application Publication
(10) Pub. No.: US 2004/0245467 A1
(43) Pub. Date: Dec. 9, 2004

(54) Method and apparatus for ir camera inspections

(76) Inventor: Tomas Lannestedt, Alvsjo (SE)

Correspondence Address: YOUNG & THOMPSON, 745 SOUTH 23RD STREET, 2ND FLOOR, ARLINGTON, VA, 22202, US

(21) Appl. No.: 10/491,168

(22) PCT Filed: Apr. 2, 2003
(86) PCT No.: PCT/SE03/00528

(30) Foreign Application Priority Data
May 21, 2002 (SE) 0201529-5

(51) Int. Cl. H01L 31/00

(52) U.S. Cl. 250/330; 382/141; 382/305; 702/1; 707/104.1

(57) ABSTRACT

A file format for storing IR images together with other types of data, such as camera settings, text information, and sound is disclosed. An apparatus and a method for bundling and analyzing data obtained via an IR camera and for determining actions to be taken based on the data are disclosed, as well as a method for gathering data.

### TECHNICAL FIELD

The present invention relates to an apparatus for IR camera inspections as defined in the preamble of claim 1. The present invention also relates to a method for IR camera inspections as defined in the preamble of claim 6 and a computer program product for IR camera inspections.

### BACKGROUND AND PRIOR ART

With an infrared (IR) camera pictures can be captured and stored internally in the camera and/or in a movable storage device like still imaging cameras for visual pictures/images.

IR cameras are generally used for preventative maintenance. When storing infrared images, the images themselves contain information about the temperature of the captured objects. By frequently inspecting different objects an early warning will be given prior to a fault or breakdown. Therefore, it is of great interest not only to view the images but also to be able to tell the different temperatures of different object, or parts of object, in the image, to analyze and draw the right conclusion from the data, and to take appropriate action.

A thermal image represents the temperature of an object and may differ significantly from a visual image. The difference may be so great that it can be hard to recognize hot or cold object parts only by looking at the IR image. Prior art IR cameras have therefore been developed which allow the storage of, for example, text comments, visual images and voice comments, in addition to the thermal data. The camera operator can store this additional information along with the image. At a later time, the images can be retrieved and compiled to a report, together with the additional information. This report may then form the basis for an action list.

It is essential that such reports be available as soon as possible and that they provide reliable information, for example, on thermal anomalies, for example in the following situations:

Inspection of fuse boxes. If an individual fuse runs hot, this means that it is overloaded.

Inspection of a power distribution systems to detect overheated electrical transformers or conductors.

Inspection of power distribution in a 3 phase electrical system. Even if the system or conductor is supposed to run at an increased temperature, one or two of the phases may be hotter than the remaining phase or phases, indicating an unbalanced load.

Inspection of an electric engine to detect overheated bearings.

Inspection of electronic components to show manufacturing errors.

Inspection of buildings to identify heat leakage caused by poor or damaged isolation.

Detection of a water leakage, which will be detected as a cool spot.

Inspection of electronic circuit boards to reveal poor design or poor assembly of the board.

When an inspection is performed, it is desirable to capture many different data from and about the object, for example, in the form of IR images, video films, voice comments or other data, for example environmental data regarding the working conditions of the object. Historical data may be collected for comparison of data from two or more occasions. The result may be a complex set of different data that is difficult to interpret in an informative way.

### OBJECT OF THE INVENTION

It is therefore an object of the present invention to make the detection of anomalies and alarm situations based on information from IR images simpler and more reliable.

### SUMMARY OF THE INVENTION

This object is achieved according to the present invention by an apparatus as defined in claim 1 and a method as defined in claim 6.

The apparatus, method and computer program of the invention may be used to indicate possible danger, or point out parts of machinery that need service. The indication may be made automatically and actions that should be taken may be pointed out automatically based on input data such as an IR image file. This provides for faster and more reliable interpretation of data, which means that action can be taken sooner when necessary, whereas unnecessary alarms can possibly be avoided.

Additional data related to the IR image may also be stored, such as one or more of the following: The calibration constants for the camera, the compensation for the background, the conditions for the detector, maximum and minimum temperatures, information about the color scales and measurement and set-up parameters.

### BRIEF DESCRIPTION OF THE DRAWINGS

The present invention will be described in more detail in the following, with reference to the appended drawings, in which:

FIG. 1 shows a prior art format for saving IR images

FIG. 2 shows a format for saving IR images, according to the invention;

FIG. 3 shows a computer adapted according to the invention;

FIG. 4 represents logically the function of the inventive program;

FIG. 5 is a flow chart of a method for gathering the information used according to the invention.

### DETAILED DESCRIPTION OF EMBODIMENTS

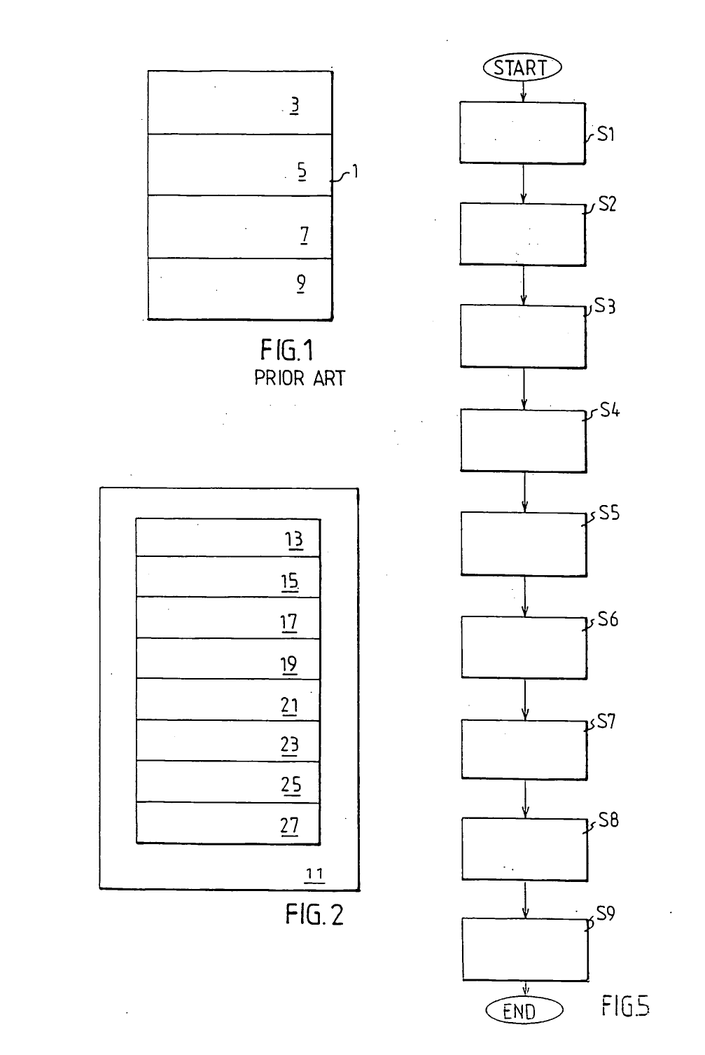

FIG. 1 shows a prior art format for saving IR images in an IR image file 1, comprising an first JPEG container 3 comprising an IR image compressed using the JPEG standard and a PNG container 5 comprising an IR image compressed using the PNG standard. The IR image file 1 further comprises a parameter container 7 comprising data such as calibration constants and camera settings and a text container 9 comprising text data. The IR image can also comprise text data, for example, temperature range information.

Other data, such as location data or sound data, or a visual image of the object may be comprised in this file, or in separate files.

FIG. 2 shows a typical format for saving IR images together with additional information in an IR image file 11. The actual thermal information used to generate the image-is processed to an image, which is preferably compressed with the JPEG standard, and stored in a JPEG image container 13 in this file. In addition to the JPEG image container 13, other containers containing other types of information may be present.

According to a preferred embodiment the IR image file comprises the following containers:

The above mentioned JPEG image container 13 holding an image of the radiation from the imaged object colored in a conventional way so as to make it easy to interpret visually, and compressed using JPEG. Preferably, the image also has visible text information such as current settings, temperature scales etc.

At least one PNG image container 15, 17, each holding an image of the radiation from the imaged object compressed using PNG. Typically there may be several images recorded at the same time from different angles. The image may be uncompressed, or may be compressed using another non-destructive standard, however, the PNG compression standard is feasible for this use.

A parameter container 19 holding the camera's calibration constants, which may be used for recalculation to get temperature readouts in the appropriate temperature scale from the saved IR image stored in the PNG container 15, 17

A settings container 21 holding the camera information, for example, camera settings and accessories, that is, lenses, and other information such as visible temperature range, date, time etc.

A text container 23 holding written text comments

A sound container 25 holding sound data/voice comments

A location container 27 comprising information about the object's location

The data may be provided through different input means on the camera, which may comprise a video camera for providing the visual image file 11 and sound recording equipment for providing the voice or sound data file 9, in addition to the IR camera functions. Some data, such as the text comments 13 and the accessory information may be entered by means of the camera or may be provided directly to the computer.

JPEG has the disadvantage of being a destructive compression standard. The information provided by the JPEG image is therefore not precise enough for measurements. Further, this image only comprises visual information, i.e. information that can be presented on a display. The JPEG image container 13 is only used to present an image of the object that can be interpreted by the human eye. Instead of the JPEG image, a photograph could be used for the same purpose.

PNG is a non-destructive compression. The PNG compressed container therefore stores an image that can be converted to temperature, using the calibration constants stored in another container. This image typically covers a greater temperature range than the JPEG image, to provide better resolution of the temperature and to enable viewing of details that were not in the visible (colored) range.

One or more files as described in connection with FIG. 1 or FIG. 2 above form the basis of a report that is generated according to the invention, as will be described in the following. If the inventive method is used with the file format of FIG. 1, a way of determining how files are associated with each other is required, for example, by means of naming conventions. This may be difficult, in particular depending on the standard file names set by other recording means.

The files may be stored in the camera, or may be transferred to an external memory, for example, the memory of a computer, before processing.

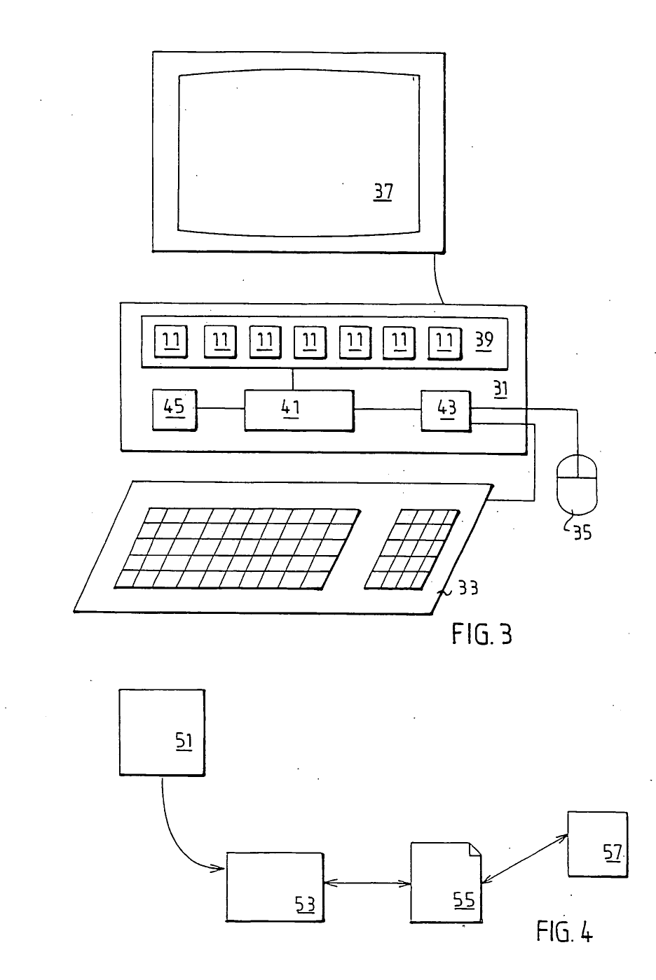

FIG. 3 shows an apparatus according to the invention. The apparatus may be, for example, a personal computer comprising a memory and processing unit 31 and user input means in the form of a keyboard 33 and/or a mouse 35 connected to the memory and processing unit. A monitor 37 may also be connected to the memory and processing unit 31.

The memory and processing unit 31 comprises a memory means 39, comprising a number of data containers 11, preferably like the one shown in FIG. 2. The data files may be transferred to the memory means 39 from an IR camera used to capture the images. Alternatively, the memory means may be provided in an IR camera (not shown) connected to the computer instead of transferring the files to the computer memory. As is common in computers, the files may be arranged in one or more directories in a file hierarchy. The memory and processing unit 31 also comprises a program 41 for analyzing the content of one or more of the files 11 according to certain criteria, as discussed above. The program 41 is triggered by an instruction means 43, for example, when the instruction means receives an instruction from one of the user input means 33, 35 to start the program 41. The computer may comprise more than one analyzing program 41. The instruction therefore preferably indicates both the program that is to be run, and the file or files 11 that should be analyzed.

Further, the computer comprises means 45 for determining the action to be taken based on the result of the analysis performed by the program 41. The action may be to store a report in a database, or to send the report to a printer, and or electronically to one or more recipients. If a serious anomaly is revealed, the action may be to issue an alarm to trigger immediate action.

The program may perform one or more of a number of different data processing functions. A simple function would be to register the temperature over the whole image and, if the temperature in any given point exceeds a defined threshold value, issue an alarm. Several threshold values can be defined, each associated with a level of alarm, ranging from “maintenance needed” to “shut down immediately”. The temperature may be measured for each pixel or several pixels may be grouped together. Grouped pixels could be triggers depending on sizes and shapes. Typical functions would be using Isotherms, i.e. analysis where areas having the same temperature are grouped together, to look for patterns of a certain size or shape that would indicate anomalies that can trigger an advice or a warning. Reference pictures of the same inspected object from a previous inspection could be used to teach the system when and at what level an action should be triggered.

Other grouped pixels, like rectangular areas or other shapes could have triggers when thermal anomalies reach a maximum or minimum threshold level or an average level, but also when standard deviation, thermal climbings per distance, and time of the day. If a process is running, the process stage the process is in may be retrieved, for example from a list in the camera, and used. A value read from another instrument may be used, such as rush hour power consumption, current process flow and others.

Several different analyses could be performed simultaneously on one image and may result in several advised actions.

If the input data files represent images of the same object at different times, for example, at fixed time intervals, the program can register the change of temperature in certain parts of the image from one image to the next and report the change of temperature. If the change rate increases, an alarm could be issued.

Alternatively, the program may use a reference image with which the files are compared. The reference image may be obtained from a storage medium in or in connection to the camera or the computer. If the difference between the registered data in any one of the images and the reference image exceeds a certain value, an alarm may be issued. The time stamp on each file indicating when it was stored may be used to determine the sequence in which the files should be analyzed.

According to a preferred embodiment, the program is implemented as a shell extension in Microsoft Windows. This has the advantage that the function used is supported in the operating system used by the computer. Also, the number of files that can form the basis of a report is unlimited. To create a report, the IR images that should be used as a basis for the report are dragged and dropped to the shell extension. The shell extension accepts the list of files and points out a script file defining the actions to be taken. Major and minor actions can be defined in the script. Major actions include: creating a report, printing the result, e-mailing the result and storing the report in a database.

Minor actions include:

checking all or some IR images for hot spots of a certain size and/or position.

checking for temperature limits and- depending on certain levels.

generating advice to repair a certain part within a specified time period based on the temperature or development of temperature of that part.

adjusting the color scheme of each image so that the same color scheme is used.

adjusting the colourization to a specific temperature.

generating action cards.

generating result tables

Instead of entering all files in one operation, it would be possible to enter the files one, or a few, at a time and let the program receive input until the operator informs the program that the input of files, is complete.

Of course, the program can be implemented in any way known in the art and the files that are to be analyzed may be input to the program in any way known in the art instead of drag‘n’drop the file names may be entered manually. The program then analyzes the input files and outputs data obtained when analyzing the files.

The program may be used for automatically pointing out thermal anomalies and associate recommendations for actions to be taken. The report may be sent to one or more recipients. Where to send the report may be made dependent on the content of the report, for example, if an anomaly is indicated it may always be sent to an alarm unit in addition to the normal recipient.

A template file associated with the shell extension or script may be used for giving the report the right structure and layout. This may be, for example, a common Word template, which may be used as a body for the resulting report. Templates can be attached or referenced from the shell extension file.

As an example, the template could specify a position in the document for a visual image and one or more IR images. Further there may be specified in the template a histogram, and a table. The table could hold data retrieved directly from one or more of the images, or could be the result of calculations based on the recorded data. For example, the maximum temperature registered may be entered in the table along with where it was detected, or the difference in temperature between two recordings could be calculated to identify any dramatic changes in temperature in a particular object or area. Typical settings in the template would be standard text comments, pre-defined IR analysis such as areas, spots, lines, histograms, result tables to be filled in and calculated from IR data obtained from the different IR image files. The template may also hold generic information such as company name and logo, date of report etc. Alternatively, the date can be extracted from the IR image files.

The template can comprise threshold values for one or more objects, or parts of the image. If the threshold value is exceeded, the template can comprise instructions for taking a particular action, such as issuing an alarm.

Sound data can be entered by means of a microphone provided on the IR camera or in any other way. This data may be typed and entered as text data at a later stage, or may be included as sound data, which may be listened to if desired.

FIG. 4 is a logical representation of one way of generating the automatic report according to the invention. On a computer screen an icon representing a data file 51, preferably of the format shown in FIG. 2, is dragged and dropped, using the mouse, to an icon 53 representing a program 55. More than one data file may be dragged and dropped, if the program should work on more than one file. The program may be, for example, a Windows shell extension. The program 55 comprises instructions for how to handle the data in the data file or files 51. The instructions may comprise minor and/or major events as defined above.

The program 55 may be associated with a template 57 in a program for presenting information. If a report is to be written, the template specifies the content and layout of the report, as discussed above. The program 55 handles the data in the files 51 according to its instructions, entering the relevant data into the appropriate parts of the template, after processing if required.

As mentioned above the program 53 can be designed to work on any file format, including that of FIG. 1, however, the file format shown in FIG. 9 has a major advantage in that the relationship between the information in different containers is well defined.

The information used according to the invention, as discussed in connection with FIG. 2 may be gathered in different ways, for example, as shown in FIG. 5. In the situation in FIG. 5, the IR camera used comprises a wizard, i.e. a computer program, designed to instruct the operator.

Step S1: The wizard comprised in the camera prompts the operator to start the inspection.

Step S2: The operator starts the inspection by registering heat radiation according to prior art.

Step S3: The wizard is activated and instructs the operator how to perform the inspection.

Step S4: The operator performs the instructions and registers IR images, video data and other data as specified in connection with FIG. 2.

Step S5: If desired, the operator uses thermography functions in the camera to analyze the IR images, for example spot meters, areas, lines and histo- grams

Step S6: The IR image is filtered and colored according to prior art techniques to present an image that can be interpreted visually.

Step S7: The operator may also check the registered data against the history of previously recorded data regarding the same area or object, to make sure that no maintenance need is building up.

Step S8: The operator closes the object inspection procedure using the trigger described in step S1, by simply pressing a stop button, or in another way.

Step S9: The collected data is bundled together, compressed using the relevant compression standards if applicable, and stored as an identifiable file for subsequent processing, for example for making a report according to the above. The file may be stored in the camera or may be transferred to a computer for further analysis, where they may form the basis for a report generated as shown in FIG. 4.

In steps S1 and S2, the operator may be assisted by the wizard guiding him to the right location, or confirming that he is in the right location. The identifier of the location can be a bar code, a numeric strip or another type of visual marker to be identified by a TV camera comprised in the IR camera. Alternatively, the trigger could be an IR signature or marker that could be identified by the IR camera. A GPS receiver can also be used as a trigger by indicating the position of the camera. In each of these cases, the camera comprises a list, or database, specifying the appropriate identifier, or location, and compares the identifier registered with the identifier comprised in the list, or compares the location data with location data comprised in the list. When there is a match, the wizard can instruct the operator, for example by means of text messages on the camera display, to start recording images.

Previously recorded images may also be stored in the camera for assisting the operator in selecting the right camera angles and so on.

1. An apparatus for processing IR images, comprising
storage means for storing at least one ir image of an imaged object in an image data file;
instruction means for receiving an instruction to analyze the at least one image data file and, upon reception of such instruction, initiate analysis of the at least one image data file;
analyzing means for analyzing the data in the at least one image data file
action means for taking action in dependence of the result of the analysis.

2. An apparatus according to claim 1, further comprising
at least one recording means for registering at least one other type of data related to the imaged object in at least a first auxiliary data file;
storing means for storing the at least first auxiliary data file in association with the at least first image data file, wherein
the means for analyzing the data in the at least one image data file is also arranged to analyze the data in the at least one auxiliary data file.

3. An apparatus according to claim 1, wherein the analyzing means is arranged to compare data concerning at least one object in the image to at least one threshold value defined for the object.

4. An apparatus according to claim 1, further comprising at least one template for generating a report in dependence of the analysis performed by the analyzing means.

5. An apparatus according to claim 1, wherein the instruction means is arranged to initiate analysis of the at least first auxiliary data file in association with the analysis of the image data file.

6. An apparatus according to claim 1, wherein the recording means comprises means for registering video data of the object.

7. An apparatus according to claim 1, wherein the recording means comprises means for registering sound data regarding the object.

8. A method of detecting the status of an object comprising the steps of
creating at least one image of the object using an IR camera,
storing said at least one image in at least one image file,
Instructing an analysis means to analyze the content of the at least one IR image file
Analyzing the content of the at least one IR image file
Taking action in dependence of the result of the analysis.

9. A method according to claim 8, further comprising registering at least one other type of data related to the image object in at least one auxiliary data file and storing said at least one auxiliary data file in association with the image data file.

10. A method according to claim 8, wherein the step of analyzing the content of the IR image file comprises the step of comparing data concerning at least one object in the image to at least one threshold value defined for the object and taking action in dependence of the result of the comparison.

11. A method according to claim 8, further comprising the step generate a report in a preset template in dependence of the result of the analysis.

12. A method according to claim 8, further comprising the steps of
determining if at least one threshold value is exceeded and, if it is,
sending the report to at least one receiver automatically.

13. A method according to claim 11, further comprising the step of sending the report to printer automatically.

14. A method according to claim 8, further comprising the step of automatically storing the report in a database.

15. An apparatus according to claim 2, wherein the analyzing means is arranged to compare data concerning at least one object in the image to at least one threshold value defined for the object.

16. A method according to claim 9, wherein the step of analyzing the content of the IR image file comprises the step of comparing data concerning at least one object in the image to at least one threshold value defined for the object and taking action in dependence of the result of the comparison.

17. A method according to claim 12, further comprising the step of sending the report to printer automatically.
